(19) United States
(12) Patent Application Publication
(10) Pub. No.: US 2025/0391099 A1
(43) Pub. Date: Dec. 25, 2025

(54) BVH OPTIMIZATION FOR ORIENTED BOUNDING BOXES

(71) Applicant: Advanced Micro Devices, Inc., Santa Clara, CA (US)

(72) Inventor: Julian Bertrand Beasley, Bellevue, WA (US)

(73) Assignee: Advanced Micro Devices, Inc., Santa Clara, CA (US)

(21) Appl. No.: 18/753,272

(22) Filed: Jun. 25, 2024

(51) Int. Cl. G06T 15/06; G06T 15/00

(52) U.S. Cl. CPC G06T 15/06; G06T 15/005; G06T 2210/12; G06T 2210/21

(57) ABSTRACT

This disclosure describes techniques for generating oriented bounding boxes within a bounding volume hierarchy. A challenging problem is in quickly identifying which orientation of a limited set corresponds to a high-fidelity characteristic orientation for a bounding box. A technique for making this identification follows. The characteristic orientation is first represented in spherical coordinates. The spherical coordinates contain three values—an azimuth value, an elevation value, which together define an axis for rotation, and a rotation value, which defines the rotation around that axis. Representing these three values in a Euclidean space (e.g., an x, y, and z space) that also includes similar points for each candidate orientation allows for quick identification of an appropriate candidate orientation. More specifically, by defining the entire possibility space for candidate orientations as a cube in this Euclidean space, and dividing this space into subcubes, it is possible to identify the appropriate candidate orientation.

### BACKGROUND

In ray tracing, a bounding volume hierarchy (BVH) is used to narrow the candidate primitives for performing an intersection test. Box nodes specify bounding boxes that bound underlying geometry. A failed test against the box node eliminates all children from consideration.

An oriented bounding box (OBB) is a type of box node that can have rotation with respect to the coordinate axes. Building a BVH to include OBBs is more computationally expensive than exclusively using AABBs. This disclosure addresses the computational costs associated with building BVHs that include OBBs.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 illustrates a ray tracing pipeline, according to an example;

FIG. 4 illustrates a bounding volume hierarchy according to an example;

FIG. 5A illustrates a bounding volume hierarchy builder;

FIG. 5B illustrates example oriented bounding boxes;

FIG. 6 is a conceptual diagram illustrating a candidate rotation, and a set of potential rotations that include a closest match to the candidate rotation, according to an example;

FIG. 7 depicts the expression of a rotation using four pieces of information, according to an example;

FIG. 8 depicts the expression of a rotation using three pieces of information, according to an example;

FIG. 9 depicts a three-dimensional lattice for identifying a rotation matrix that matches a characteristic rotation, according to an example;

FIG. 10 is a conceptual diagram illustrating a rotation and its reflection, in accordance with a further example; and

FIG. 11 is a flow diagram of a method for generating OBBs within a BVH, according to an example.

### DETAILED DESCRIPTION

This disclosure describes techniques for generating OBBs within a BVH. In the course of building a BVH, in the event that a box node is determined to be an oriented bounding box, a characteristic orientation for the box node is determined based on the geometry of triangles assigned to that box node. The characteristic orientation is defined with a relatively high fidelity, such as with a rotation matrix that includes a set of floating point values (e.g., 32-bit floating point values) that, together, define the orientation. To save space, in the BVH, orientations are limited to a relatively small set of possible orientations (“candidate orientations”), rather than permitting all possible orientations describable with a high fidelity matrix (e.g., that includes 32-bit floating point numbers). A challenging problem associated with this limitation is in quickly identifying which orientation of the limited set of orientations corresponds to the high-fidelity characteristic orientation.

In the present disclosure, a technique for making this identification is as follows. First, the characteristic orientation is first represented in spherical coordinates. The spherical coordinates are then used to quickly identify one of the candidate orientations with the use of analysis in a Euclidean coordinate system that represents the spherical coordinates. More specifically, the spherical coordinates contain three values—an azimuth value, an elevation value, which together define an axis for rotation, and a rotation value, which defines the rotation around that axis. Representing these three values in a Euclidean space (e.g., an x, y, and z space) that also includes similar points for each candidate orientation allows for quick identification of an appropriate candidate orientation. More specifically, by defining the entire possibility space for candidate orientations as a cube in this Euclidean space (sometimes referred to as a “lattice” here), and dividing this space into subcubes, each of which contains zero or more candidate orientations (based on their Euclidean coordinates), it is possible to identify the appropriate candidate orientation. Specifically, by locating the subcube of the characteristic orientation, it is known that the candidate orientation associated with that subcube is the appropriate orientation. Note that even if a subcube does not actually contain the coordinate for a candidate orientation, it is still possible to associate the closest candidate orientation to that subcube in Euclidean space to that subcube, such that locating a characteristic orientation in a particular subcube automatically results in selection of a candidate orientation.

In summary, it is possible to identify an appropriate candidate rotation for a particular characteristic rotation by representing all rotations as spherical coordinates, reinterpreting these coordinates as Euclidean coordinates, and identifying which “subcube” within the Euclidean space contains the Euclidean coordinate for the characteristic rotation is within. Since each such subcube is associated with a particular candidate orientation (which is either within that subcube or is near that subcube in the event that, e.g., the subcube contains no candidate orientations), location of the characteristic orientation within any given subcube quickly and easily provides a selected candidate orientation for the characteristic orientation. This technique is in contrast with other methods which may, for example, perform a brute force search that tests every candidate orientation for closeness to the characteristic orientation, which is much slower.

In some examples, the subcubes in differ in size in order to account for the fact that candidate subdivisions may be more dense near the equator of the spherical coordinate system than near the poles. In some such cases, the subcubes closer to the middle of the cube are smaller than subcubes on the outside of the cube. In some examples, the lattice is a hierarchical lattice.

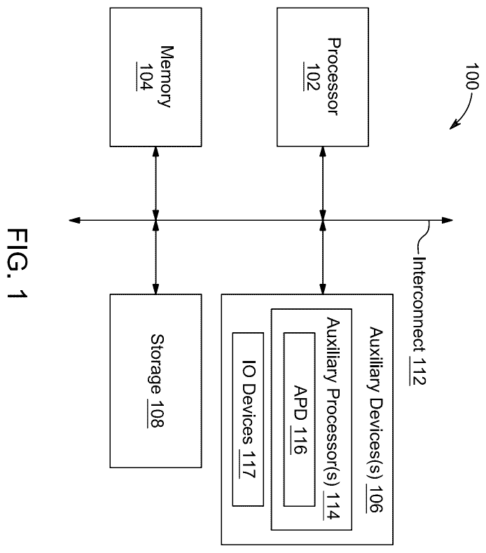

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

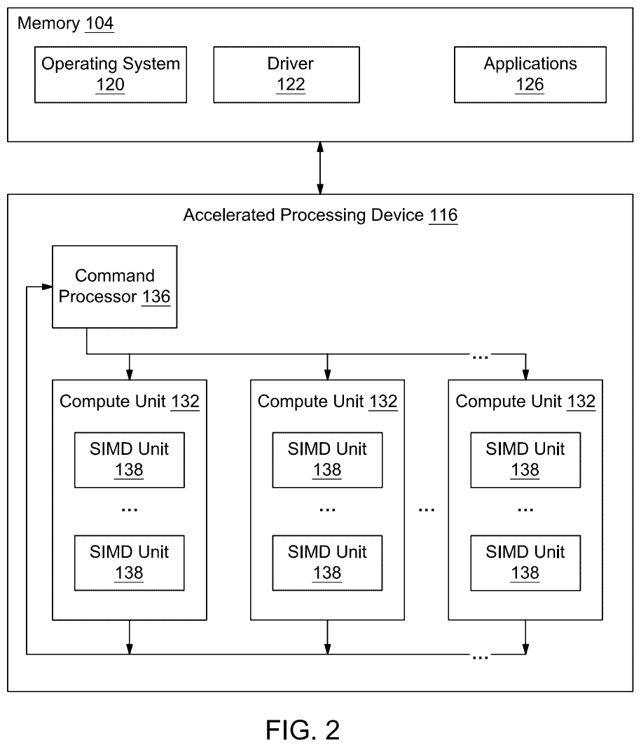

FIG. 2 illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to a display device based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. A command processor 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

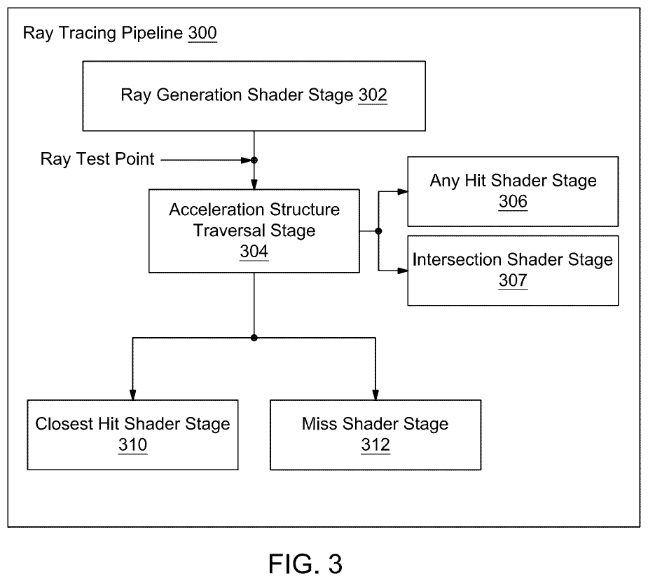

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, intersection shader 307, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs the ray intersection test to determine whether a ray hits a triangle. The other programmable shader stages (ray generation shader 302, any hit shader 306, closest hit shader 310, miss shader 312) are implemented as shader programs that execute on the SIMD units 138. The acceleration structure traversal stage is implemented in software (e.g., as a shader program executing on the SIMD units 138), in hardware, or as a combination of hardware and software. The ray tracing pipeline 300 may be orchestrated partially or fully in software or partially or fully in hardware, and may be orchestrated by the processor 102, the command processor 136, by a combination thereof, or partially or fully by any other hardware and/or software unit. In examples, traversal through the ray tracing pipeline 300 is performed partially or fully by the command processor 136, either autonomously or under control of the processor 102, or partially or fully by a shader program (such as a bounding volume hierarchy traversal shader program) executing on one or more of the SIMD units 138. In some examples, testing a ray against boxes and triangles (inside the acceleration structure traversal stage 304) is hardware accelerated (meaning that a fixed function hardware unit performs the steps for those tests). In other examples, such testing is performed by software such as a shader program executing on one or more SIMD units 138. Herein, where the phrase “the ray tracing pipeline does [a thing]” is used, this means that the hardware and/or software that implements the ray tracing pipeline 300 does that thing.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects within the scene, and tests the ray against triangles in the scene. During this traversal, for triangles that are intersected by the ray, the ray tracing pipeline 300 triggers execution of an any hit shader 306 and/or an intersection shader 307 if those shaders are specified by the material of the intersected triangle. Note that multiple triangles can be intersected by a single ray. It is not guaranteed that the acceleration structure traversal stage will traverse the acceleration structure in the order from closest-to-ray-origin to farthest-from-ray-origin. The acceleration structure traversal stage 304 triggers execution of a closest hit shader 310 for the triangle closest to the origin of the ray that the ray hits, or, if no triangles were hit, triggers a miss shader.

Note, it is possible for the any hit shader 306 or intersection shader 307 to “reject” an intersection from the acceleration structure traversal stage 304, and thus the acceleration structure traversal stage 304 triggers execution of the miss shader 312 if no intersections are found to occur with the ray or if one or more intersections are found but are all rejected by the any hit shader 306 and/or intersection shader 307. An example circumstance in which an any hit shader 306 may “reject” a hit is when at least a portion of a triangle that the acceleration structure traversal stage 304 reports as being hit is fully transparent. Because the acceleration structure traversal stage 304 only tests geometry, and not transparency, the any hit shader 306 that is invoked due to an intersection with a triangle having at least some transparency may determine that the reported intersection should not count as a hit due to “intersecting” a transparent portion of the triangle. A typical use for the closest hit shader 310 is to color a ray based on a texture for the material. A typical use for the miss shader 312 is to color a ray with a color set by a skybox. It should be understood that the shader programs defined for the closest hit shader 310 and miss shader 312 may implement a wide variety of techniques for coloring ray and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel.

It is possible for any of the any hit shader 306, intersection shader 307, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray intersects an object is referred to herein as a “ray intersection test.” The ray intersection test involves shooting a ray from an origin and determining whether the ray intersects a triangle and, if so, what distance from the origin the triangle intersection is at. For efficiency, the ray tracing test uses a representation of space referred to as a bounding volume hierarchy. This bounding volume hierarchy is the “acceleration structure” referred to elsewhere herein. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray intersection test can be performed.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

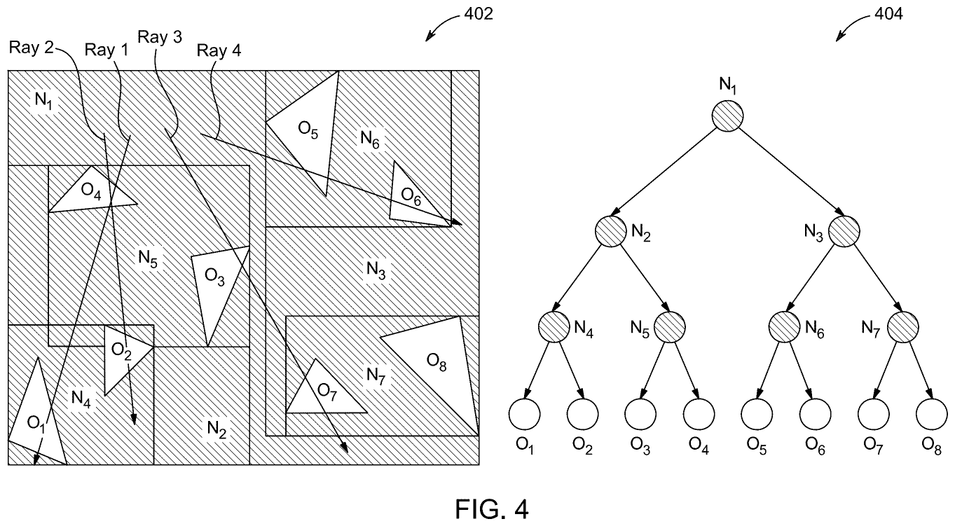

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the test for that non-leaf node fails. In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that Ne succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

The ray tracing pipeline 300 casts rays to detect whether the rays hit triangles and how such hits should be shaded. Each triangle is assigned a material, which specifies which closest hit shader should be executed for that triangle at the closest hit shader stage 310, as well as whether an any hit shader should be executed at the any hit shader stage 306, whether an intersection shader should be executed at the intersection shader stage 307, and the specific any hit shader and intersection shader to execute at those stages if those shaders are to be executed.

Thus, in shooting a ray, the ray tracing pipeline 300 evaluates intersections detected at the acceleration structure traversal stage 304 as follows. If a ray is determined to intersect a triangle, then if the material for that triangle has at least an any hit shader or an intersection shader, the ray tracing pipeline 300 runs the intersection shader and/or any hit shader to determine whether the intersection should be deemed a hit or a miss. If neither an any hit shader or an intersection shader is specified for a particular material, then an intersection reported by the acceleration structure traversal 304 with a triangle having that material is deemed to be a hit.

Some examples of situations where an any hit shader or intersection shader do not count intersections as hits are now provided. In one example, if alpha is 0, meaning fully transparent, at the point that the ray intersects the triangle, then the any hit shader deems such an intersection to not be a hit. In another example, an any hit shader determines that the point that the ray intersects the triangle is deemed to be at a “cutout” portion of the triangle (where a cutout “cuts out” portions of a triangle by designating those portions as portions that a ray cannot hit), and therefore deems that intersection to not be a hit.

Once the acceleration structure has been fully traversed, the ray tracing pipeline 300 runs the closest hit shader 310 on the closest triangle determined to hit the ray. As with the any hit shader 306 and the intersection shader 307, the closest hit shader 310 to be run for a particular triangle is dependent on the material assigned to that triangle.

In sum, the ray tracing pipeline 300 traverses the acceleration structure 304, determining which triangle is the closest hit for a given ray. The any hit shaders and intersection shaders evaluate intersections—potential hits—to determine if those intersections should be counted as actual hits. Then, for the closest triangle whose intersection is counted as an actual hit, the ray tracing pipeline 300 executes the closest hit shader for that triangle. If no triangles count as a hit, then the ray tracing pipeline 300 executes the miss shader for the ray.

Operation of the ray tracing pipeline 300 is now discussed with respect to the example rays 1-4 illustrated in FIG. 4. For each of the example rays 1-4, the ray tracing pipeline 300 determines which triangles those rays intersect. The ray tracing pipeline 300 executes appropriate any hit shaders 306 and/or intersection shaders 307, as specified by the materials of the intersected triangles, in order to determine the closest hit that does not miss (and thus the closest-hit triangle). The ray tracing pipeline 300 runs the closest hit shader for that closest-hit triangle.

In an example, for ray 1, the ray racing pipeline 300 runs the closest hit shader for O₄ unless that triangle had an any hit shader or intersection shader that, when executed, indicated that ray 1 did not hit that triangle. In that situation, the ray tracing pipeline 300 would run the closest hit shader for O₁ unless that triangle had an any hit shader or intersection shader indicating that triangle was not hit by ray 1, and in that situation, the ray tracing pipeline 300 would execute a miss shader 312 for ray 1. Similar operations would occur for rays 2, 3, and 4. For ray 2, the ray tracing pipeline 300 determines that intersections occur with O₂ and O₄, executes an any hit and/or an intersection shader for those triangles if specified by the material, and runs the appropriate closest hit or miss shader. For rays 3 and 4, the ray tracing pipeline 300 determines intersections as shown (ray 3 intersects O₅ and O₇ and ray 4 intersects O₅ and O₆), executes appropriate any hit and an/or intersection shaders, and executes appropriate closest hit or miss shaders based on the results of the any hit and/or intersection shaders.

As stated above, a BVH is used to evaluate traversal of a scene for rendering. Oriented bounding boxes improve performance of such a scene, but care must be taken to build BVHs using oriented bounding boxes accurately and performantly.

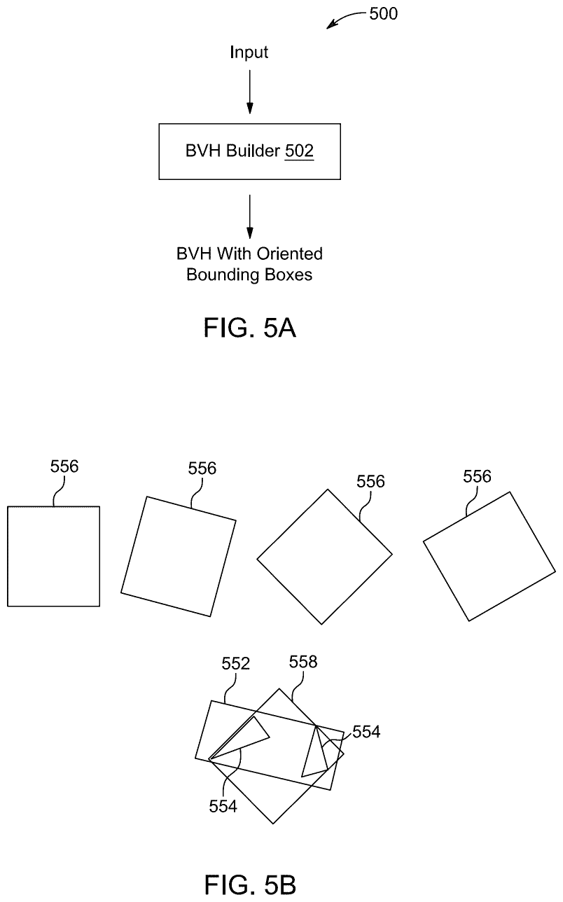

FIG. 5A is a system 500 for building a BVH including an oriented bounding box, according to an example. The system 500 includes a BVH builder 502, which accepts input and generates a BVH with oriented bounding boxes. The BVH builder 502 is implemented as hardware (e.g., circuitry, such as a programmable or fixed function processor, or as combination thereof), software (e.g., a driver or other software executing on the processor 102, software, such as a shader, executing on the APD 116, or as some other form of software), or as a combination thereof. In some examples, the processor 102 requests the APD 116 to render geometry of a scene and the BVH builder 502 builds a BVH for the scene in response. Part of such building includes determining orientations for bounding boxes of bounding box nodes of the BVH. The input may be an already existing BVH that the BVH builder 502 modifies to include one or more oriented bounding volumes, or the input may be scene geometry from which the BVH builder 502 generates a BVH including oriented bounding boxes.

FIG. 5B is a diagram illustrating the comparison between a characteristic orientation 552 for underlying geometry 554 and candidate rotations 556, according to an example.

The underlying geometry 554 is illustrated as being two triangles. However, the underlying geometry 554 could be any type of primitive, or could include bounding volumes or other means for specifying geometry. The characteristic orientation 552 describes a “preferred” orientation for a bounding box that bounds the underlying geometry 554. Any technically feasible means for obtaining this characteristic orientation is possible. In an example, obtaining the characteristic orientation includes selecting a characteristic orientation for a box that tightly bounds all underlying geometry 554 and has the lowest total surface area (e.g., surface area of all faces of the bounding volume) out of all orientations that tightly bound the underlying geometry 554. Any other technically feasible means for generating the characteristic orientation is possible.

The candidate orientations 556 are the possible orientations that an oriented bounding box can actually have in the BVH. It is possible, and in fact very likely, that the characteristic orientation 552 is not one of the candidate orientations 556. Thus, in order to record an orientation into the BVH for an oriented bounding box node, the BVH builder 502 selects a candidate orientation 556 that is “appropriate” given the characteristic orientation 552. A selected candidate orientation 558 is illustrated in FIG. 5B.

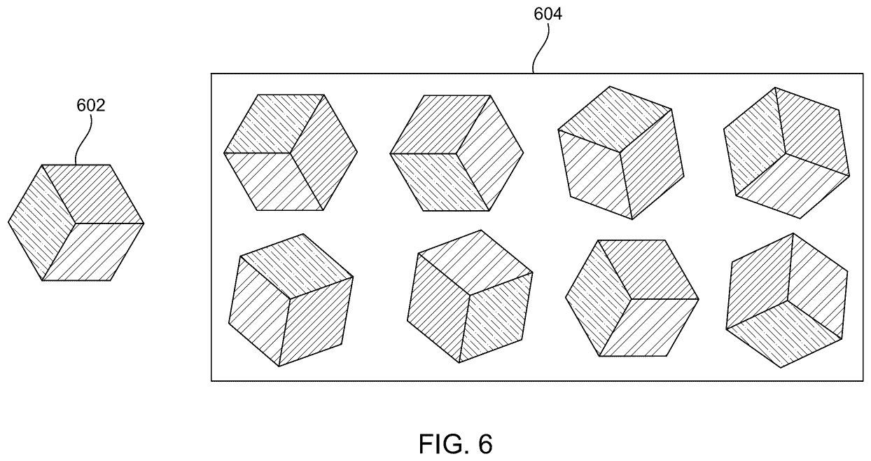

Although FIG. 5B illustrates the concept of an oriented bounding boxes, such bounding boxes in a 2-dimensional space for purposes of explanation, bounding boxes in a BVH would be in a 3-dimensional space. FIG. 6 illustrates examples of such bounding boxes. More specifically, FIG. 6 is a conceptual diagram illustrating a characteristic rotation 602 of bounding volume node, and a set 604 of candidate orientations of a limited set of rotations. Each shape in set 604 corresponds to a specific rotation, which can be described as an associated rotation matrix. During building of the BVH, one of the rotations represented in set 604 is selected for a corresponding bounding volume node. In some examples, this selection involves identifying within set 604 the rotation represents a closest match to the characteristic rotation 602. While in the example shown set 604 has only eight members, it will be understood that the number of rotations represented in the set can be greater or less than that amount (and in some cases, much greater).

Each rotation matrix represented in set 604 corresponds to the combination of (i) a specific axis along which the bounding volume is aligned, and (ii) an angular rotation of the bounding volume about such axis.

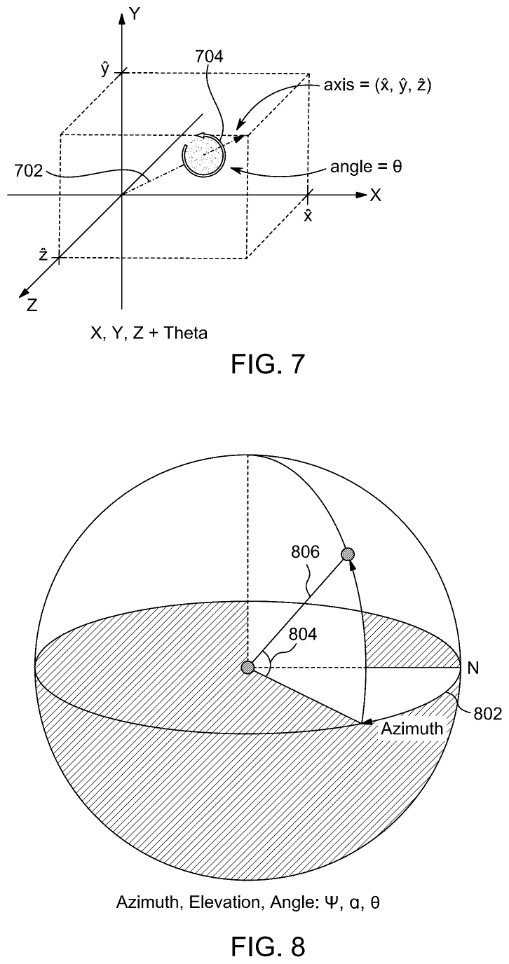

FIG. 7 depicts the expression of a rotation using four pieces of information, namely (i) x, y and z values that define an axis 702 along which the bounding volume is aligned (e.g., as a vector from the origin), and (ii) a theta value representing an angular rotation 704 about axis 702. Alternatively, FIG. 8 depicts a method for expressing a rotation using three pieces of information, namely (i) an azimuth 802 and elevation angle 804 that define an axis 806 along which bounding volume is aligned, and (ii) a theta value representing an angular rotation (not shown) about axis 806. In embodiments discussed below, the efficiency of the task of selecting a rotation from set 604 for a working node is enhanced by using a notation with fewer items of information (e.g., as shown in FIG. 8) to express each rotation.

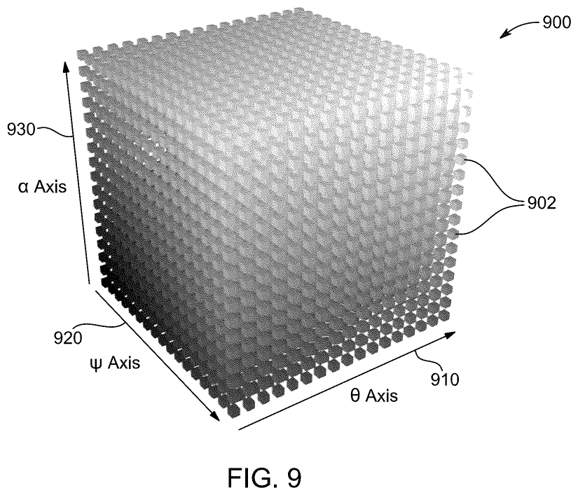

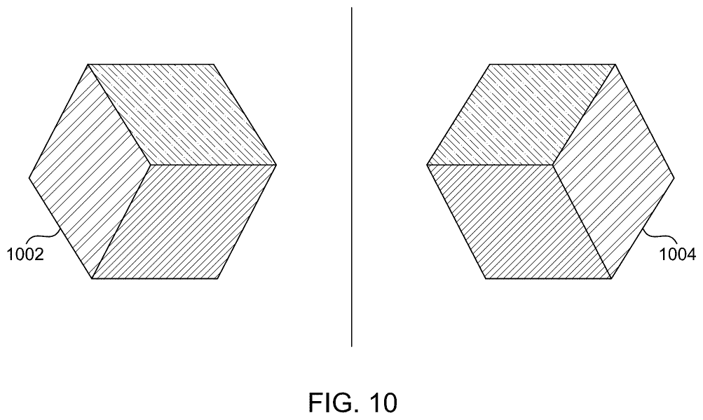

FIG. 9 depicts a three-dimensional lattice 900 that can be used to analytically identify a candidate orientation from a set of candidate orientations, according to an example. As shown, lattice 900 is divided into subcubes 902, each of which corresponds to one (or more) of the precomputed (“candidate”) rotation matrices. In the example shown, axes 910, 920 and 930 are respectively associated with the theta, azimuth and elevation angle values for rotations expressed using the notation described above in connection with FIG. 8. It should be understood that the lattice 900 represents a Euclidean coordinate space—i.e., a space with x, y, and z coordinates. The idea that the spherical coordinates azimuth, elevation, and rotation are represented in this coordinate system means that the values of each of these spherical coordinates are used as the x, y, and z values in the Euclidean space. Thus, any given point in the Euclidean space represents a particular orientation for a bounding box. For example, point x=50, y=50, and z=50, might represents 50 degrees of azimuth, 50 degrees of elevation, and 50 degrees of rotation.

Each subcube 902 corresponds to one or more precomputed rotation matrices for one or more corresponding candidate orientations. The points for such rotation matrices may fall within the area of the corresponding subcube, but it is also possible that any given subcube does not contain any candidate orientations. For example, given a subcube that spans between values 10-15, 10-15, and 10-15, it is possible that there are no candidate orientations that have spherical coordinates within those values. However, such subcube will still be associated with a particular candidate orientation, which can be one that is closest to the subcube.

Given a set of candidate orientations, each such orientation can be placed within a particular subcube of the lattice 900 based on the spherical coordinates (azimuth, elevation angle, and rotation theta). During BVH building, to select one of the candidate orientations, a particular subcube 902 is selected based on the spherical coordinates of the characteristic orientation. Specifically, the selected subcube 902 is the subcube that contains the point defined by such spherical coordinates. Then, the BVH builder 502 selects one of the candidate orientations associated with that subcube 902 as the selected candidate orientation for the bounding volume. If there are multiple such candidate orientations, then the BVH builder 502 selects any such candidate orientation. Again, it is possible that the volume for a subcube does not actually contain the point of any candidate orientation, but such subcube will still be associated with a candidate orientation, such as that having the closest point to the subcube.

Once a candidate orientation is selected, the BVH builder 502 stores an indication of that selected candidate orientation with the non-leaf node to which that orientation is applied. This information can be stored in any technically feasible manner. In an example, the information is stored as an index into a lookup table (e.g., an array or other data structure) that stores the full rotation matrix of each candidate orientation. In some examples, the BVH builder 502 obtains such an index based on a characteristic coordinate for the subcube 902 in which the spherical coordinates of the characteristic orientation lies. A translation table can store mappings between such subcube characteristic coordinates and lookup table indices. In an example, the characteristic coordinate for the subcube 902 is the coordinate of the center point of the subcube 902 or is any other point within or characteristic of the subcube. Thus a table would include a translation from a value indicating the centerpoint of the subcube and a rotation matrix.

When the BVH is used for operations such as ray tracing, the index value stored in the node is used to look up and retrieve the rotation matrix that is applied to the node during ray tracing (e.g., for determining whether a ray intersects such a bounding volume). Then, the orientation is applied to the bounding box and a ray is tested for intersection with the oriented bounding box.

While lattice 900 is depicted as having subcubes that are equal in size, in other embodiments the size of the subcubes varies within the lattice. In one case where, for example, potential rotations modelled within the subcubes are not evenly dispersed within the lattice, the sizes of the subcubes within the lattice are varied in a manner that attempts to equalize the number of rotations captured by the volume of each subcube. In some such examples, subcubes closer to a middle of the lattice are smaller than subcubes on an outside of the lattice, and the size of the subcubes increases as the distance from the center of the lattice increases. This configuration accounts for the fact that spherical coordinates that are evenly spaced numerically will be denser in the spherical coordinate space towards the equator of the sphere as compared with at the poles of the sphere.

In some examples, the lattice is a hierarchical structure. Each level of the hierarchy includes a set of subcubes. A lookup to this lattice results in a selection of one such subcube. At least one such subcube is associated with, and points to a subsequent level of the hierarchy. At the bottom-most level of the hierarchy, each subcube is associated with a single orientation. An orientation can be found at any level of the hierarchy, and different levels can have orientations. This hierarchical structure allows large areas of the structure that have the same orientation to be represented with a relatively small amount of data, with other areas that have more detailed variation in orientation to be represented with the necessary larger amount of data.

In some examples of a BVH build, the characteristic orientation determined for a working node is supplied in a form that includes unlabeled axes. For example, three values corresponding to the X, Y and Z axes are provided, but information specifying which value corresponds to the X axis, which value corresponds to the Y axis and which corresponds to the Z axis, is not supplied. In such a case, the three unlabeled values collectively map to six potential rotations (e.g., XYZ, YXZ, ZYX, XZY, YZX and ZYX). In one example, during the BVH build, a closest match to each of the six potential rotations is initially determined. A score is given to each of the six closest matches depending on the distance in the 3D space of the lattice between a particular potential rotation and its closest match. In this example, a higher score represents a shorter distance between the potential rotation and its closest match. From the six potential rotations, the one with the highest score is selected and the index of the subcube associated with the highest score is used for the orientation of the bounding volume.

In one embodiment where the characteristic orientation determined for orientation of the bounding volume is supplied in a form that includes unlabeled axes, the determination of the closest match within lattice 900 is streamlined by ignoring the duplicated orientations that are just reflections of already considered orientations. FIG. 10 is a conceptual diagram illustrating a rotation 1002 and its reflection 1004. By taking the determinant of a matrix, the system distinguishes between pure rotations (which have a positive determinant) and reflections (which have a negative determinant).

In one example of a case where the characteristic orientation determined for a bounding volume is supplied in a form that includes unlabeled axes, the determinant associated with each of the six potential rotations is taken, and a closest match is found in the lattice for only the three potential rotations with a positive determinant. From these three potential rotations, the one with the highest score is selected and the index of the subcube associated with the highest score is used for the bounding volume. The “score” can be determined in any technically feasible manner, such as by how close the point defining characteristic orientation is to the point defining the candidate orientation in the Euclidean space. By ignoring the three potential rotations that are reflections in this process, determination of the closest match within lattice 900 is streamlined.

Put differently, sometimes it is the case that the characteristic orientation is provided without axes that are labeled. In other words, it is the task of the lookup using the lattice 900 to select an orientation from the candidate orientations. In doing so, in some examples, the BVH builder 502 considers multiple candidate orientations by labeling the axes of the characteristic orientation in each possible way, eliminating reflections. In other words, it is possible to label the first coordinate provided as azimuth, the second as elevation, and the third as rotation angle, or to label the first as elevation, the second as azimuth, and the third as rotation angle, as so on. Each such selection is evaluated for closeness to one of the candidate orientations represented in the lattice 900. In some examples, to evaluate the selection for closeness, each such selection is placed into a subcube 902 and a Euclidean distance between the point representing that selection and that representing a candidate orientation is taken. In some such examples, the selection having the closest Euclidean distance to any such candidate orientation represents a selected axis labeling and the candidate orientation having the closest Euclidean distance to such selected orientation is selected as the orientation for the bounding volume. It is noted that although there are six possible combinations of axis labeling, these combinations include three which are reflections of the other three. Thus, it is possible to consider only three possible axis labels, rather than six, by eliminating those axis labelings that are reflections of the others.

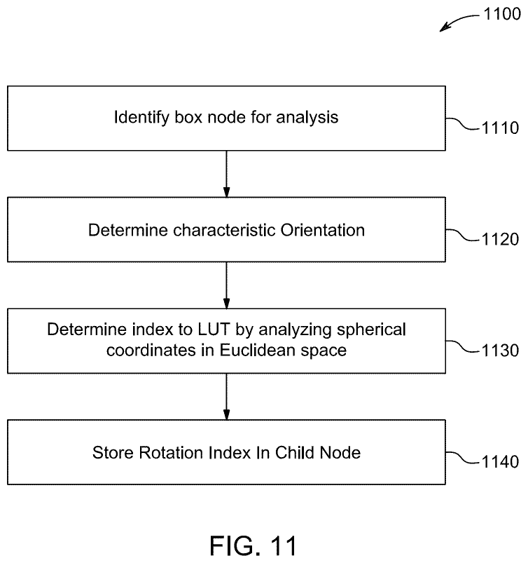

FIG. 11 is a flow diagram of a method 1100 for generating OBBs within a BVH, according to an example. Although described with respect to the system of FIGS. 1-10, those of skill in the art will recognize that any system configured to perform the steps of the method 1100 in any technically feasible order falls within the scope of the present disclosure.

In step 1110, a BVH builder 502 identifies a box node for which an orientation is to be determined. Any technically feasible technique may be used to determine that a particular box node in a BVH should be an oriented bounding box. In some examples, each box node is given an orientation. In other examples, the BVH builder 502 applies any technically feasible selection criteria.

In step 1120, the system determines a characteristic orientation for the first child node based on an underlying geometry of triangles in the first child node. Any technically feasible technique for performing such determination can be used. In various examples, the system selects an orientation such that a box having that orientation minimizes or maximizes a fitness measure for that orientation. In some examples, the fitness measure is a minimum sum of box face area. In other words, the measure adds the area of all faces of a box with a given orientation that tightly bounds the underlying geometry and selects the orientation that produces the lowest such measure. Any other technically feasible means for selecting a characteristic orientation is possible. It should be understood that the possible characteristic orientations are not limited to the orientations represented by the precomputed rotation matrices discussed elsewhere herein.

In step 1130, an index into a lookup table of precomputed rotation matrices is selected in accordance with the characteristic orientation. In one example, the lookup table corresponds to a 3D lattice of potential rotations. In other examples, lattices of other dimensions are used. In one example, the lattice corresponds to a cube that is subdivided into a plurality of subcubes, and a point within each subcube corresponds to a potential rotation (“candidate orientation”). In some such examples, the system selects the index into the lookup table by identifying a subcube that contains the Euclidean-space-converted spherical coordinates of the characteristic orientation. More specifically, the characteristic orientation is represented by three values (e.g., an azimuth, an elevation, and an angle) each of which maps to an axis of the lattice. A characteristic orientation corresponds to a subcube 902 if the characteristic orientation, mapped into the Euclidean space of the lattice 900, falls within that subcube. In some embodiments, the subcubes in the lattice differ in a size. For example, subcubes closer to a middle of the lattice are smaller than subcubes on the outside of the lattice.

Each candidate orientation represented by the lattice 900 is associated with an index into a separate lookup table that stores information about the orientation (e.g., the rotation matrix for that candidate orientation). Thus, selecting a particular candidate orientation based on the subcubes as described above 902 leads to selection of the index for that candidate orientation.

In step 1140, the index selected in step 1106 is stored in the box node as part of building the BVH. As a result, the box node stores an index to a lookup table storing orientations and thus has information indicating how the bounding volume of the box node is oriented.

Subsequent to building the BVH, a system performs an operation such as an intersection test using the box node with the stored index. In such an operation, a precomputed rotation matrix is retrieved from the lookup table based on the index and applied to a bounding box represented by the child node to form a rotated bounding box which is then tested for an intersection.

The various functional units illustrated in the figures and/or described herein (including, but not limited to, the processor 102, the accelerated processing device 116, the command processor 136, the compute units 132, the SIMD units 138, ray tracing pipeline 300, ray generation shader 302, acceleration structure traversal stage 304, any hit shader 306, hit or miss unit 308, closest hit shader 310, miss shader 312, or BVH builder 502 may be implemented as a general purpose computer, a processor, or a processor core, or as a program, software, or firmware, stored in a non-transitory computer readable medium or in another medium, executable by a general purpose computer, a processor, or a processor core.

It should be understood that many variations are possible based on the disclosure herein. Although features and elements are described above in particular combinations, each feature or element can be used alone without the other features and elements or in various combinations with or without other features and elements.

The methods provided can be implemented in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be mask works that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
determining a characteristic orientation for a node based on an underlying geometry of triangles of the node;
assigning a candidate orientation to the node, based on Euclidean coordinates representative of the characteristic orientation; and
building a BVH using the node having the characteristic orientation.

2. The method of claim 1, wherein assigning the candidate orientation to the node comprises selecting an index into a lookup table for the candidate orientation.

3. The method of claim 2, further comprising performing an intersection test on the node by retrieving a precomputed rotation matrix from the lookup table based on the index, applying the precomputed rotation matrix to a bounding box for the node to form a rotated bounding box, and testing the rotated bounded box for an intersection.

4. The method of claim 1, wherein assigning the orientation to the node based on the Euclidean coordinates comprises identifying which subcube of a lattice the Euclidean coordinates are within and selecting a candidate orientation of the subcube as the candidate orientation.

5. The method of claim 4, wherein the Euclidean coordinates comprises coordinates in a Euclidean space whose magnitude is equal to magnitudes of spherical coordinates defining the characteristic orientation.

6. The method of claim 5, wherein the spherical coordinates correspond to an azimuth, an elevation, and an angle.

7. The method of claim 4, wherein the subcubes in differ in size.

8. The method of claim 7, wherein subcubes closer to a middle of a cube for the lattice are smaller than subcubes on an outside of the cube.

9. The method of claim 1, wherein the candidate orientation is provided without labeled axes.

10. A system comprising:
a memory configured to store a BVH; and
a processor configured to perform operations comprising:
determining a characteristic orientation for a node based on an underlying geometry of triangles of the node;
assigning a candidate orientation to the node, based on Euclidean coordinates representative of the characteristic orientation; and
building the BVH using the node having the characteristic orientation.

11. The system of claim 10, wherein assigning the candidate orientation to the node comprises selecting an index into a lookup table for the candidate orientation.

12. The system of claim 11, wherein the operations further comprise performing an intersection test on the node by retrieving a precomputed rotation matrix from the lookup table based on the index, applying the precomputed rotation matrix to a bounding box for the node to form a rotated bounding box, and testing the rotated bounded box for an intersection.

13. The system of claim 10, wherein assigning the orientation to the node based on the Euclidean coordinates comprises identifying which subcube of a lattice the Euclidean coordinates are within and selecting a candidate orientation of the subcube as the candidate orientation.

14. The system of claim 13, wherein the Euclidean coordinates comprises coordinates in a Euclidean space whose magnitude is equal to magnitudes of spherical coordinates defining the characteristic orientation.

15. The system of claim 14, wherein the spherical coordinates correspond to an azimuth, an elevation, and an angle.

16. The system of claim 13, wherein the subcubes in differ in size.

17. The system of claim 16, wherein subcubes closer to a middle of a cube for the lattice are smaller than subcubes on an outside of the cube.

18. The system of claim 10, wherein the candidate orientation is provided without labeled axes.

19. A non-transitory computer-readable medium storing instructions that, when executed by a processor, cause the processor to perform operations comprising:
determining a characteristic orientation for a node based on an underlying geometry of triangles of the node;
assigning a candidate orientation to the node, based on Euclidean coordinates representative of the characteristic orientation; and
building a BVH using the node having the characteristic orientation.

20. The non-transitory computer-readable medium of claim 19, wherein assigning the candidate orientation to the node comprises selecting an index into a lookup table for the candidate orientation.
